(19) United States
(12) Patent Application Publication
(10) Pub. No.: US 2025/0365084 A1
(43) Pub. Date: Nov. 27, 2025

(54) TERMINAL APPARATUS, BASE STATION APPARATUS, CONTROL METHOD, AND A NON-TRANSITORY COMPUTER-READABLE STORAGE MEDIUM

(71) Applicant: KDDI CORPORATION, Tokyo (JP)

(72) Inventors: Tomohiro OHIRA, Tokyo (JP); Toshiaki YAMAMOTO, Tokyo (JP)

(21) Appl. No.: 19/293,678

(22) Filed: Aug. 7, 2025

Related U.S. Application Data
(63) Continuation of application No. PCT/JP2024/005142, filed on Feb. 15, 2024.

(30) Foreign Application Priority Data
Feb. 28, 2023 (JP) 2023-030101

(51) Int. Cl. H04B 17/345; H04L 5/00

(52) U.S. Cl. CPC H04B 17/345; H04L 5/0048

(57) ABSTRACT

A terminal apparatus performs: receiving a notification signal from a base station apparatus, the notification signal including information indicating respective priorities for at least one of a first measurement method for measuring received power of a reference signal, a second measurement method for measuring reception quality of the reference signal based on a ratio of a signal strength of the reference signal to a signal strength of a predetermined resource including a resource where the reference signal is transmitted, and a third measurement method for measuring a signal-to-noise ratio of the reference signal; selecting at least one of the measurement methods based on the priorities; performing measurement of radio signals transmitted from the base station apparatus and another base station apparatus with the selected measurement method; and controlling connection with the base station apparatus according to a measurement result.

### CROSS-REFERENCE TO RELATED APPLICATION(S)

This application is a continuation of International Patent Application No. PCT/JP2024/005142 filed on Feb. 15, 2024, which claims priority to and the benefit of Japanese Patent Application No. 2023-030101 filed on Feb. 28, 2023, the entire disclosures of which are incorporated herein by reference.

### BACKGROUND OF THE INVENTION

### Field of the Invention

The present invention relates to a terminal apparatus, a base station apparatus, a control method, and a non-transitory computer-readable storage medium for performing measurement of radio signals.

### Description of the Related Art

In the cellular communication standard of the 5th Generation (5G) of the 3rd Generation Partnership Project (3GPP (registered trademark)), mobility control is defined in which a terminal apparatus performs a handover based on a measurement result of a reference signal transmitted from a base station apparatus of a neighboring cell. If the measurement result of the reference signal transmitted from the base station apparatus of the neighboring cell satisfies a predetermined condition in a connected (RRC_Connected) state, the terminal apparatus transmits a measurement report indicating the occurrence of a handover trigger event to its base station apparatus. When the terminal apparatus is in an idle (RRC_Idle) or inactive (RRC_Inactive) state, the terminal apparatus performs mobility control processing such as cell reselection (see 3GPP TS38.331, V17.0.0, April 2022).

### SUMMARY OF THE INVENTION

Here, the terminal apparatus may be able to perform measurement of the reference signal with a plurality of methods. Here, depending on the connected state between the terminal apparatus and the base station apparatus, the terminal apparatus may measure reference signals transmitted from other base station apparatuses with different measurement methods. Also, the terminal apparatus may perform a handover to a cell with a high interference strength as a result of performing measurement of a reference signal with a method different from a method for measuring the ratio of the signal strength of a reference signal to the signal strength of interference and noise. Thus, the inability of the terminal apparatus to appropriately control the measurement method of the reference signal results in the problem that appropriate mobility control of the terminal apparatus cannot be performed.

The present invention provides a technique for enabling appropriate control of measurement methods of reference signals performed by a terminal apparatus.

A terminal apparatus according to an aspect of the present invention performs to: a terminal apparatus comprising: at least one processor; and a memory; wherein the at least one processor is configured, by executes executing computer executable instructions stored in the memory, to: receive a notification signal from a base station apparatus, the notification signal including information indicating respective priorities for one of, and a combination of two or more of a first measurement method, a second measurement method, and a third measurement method, the first measurement method being a method for measuring received power of a reference signal transmitted from the base station apparatus, the second measurement method being a method for measuring reception quality of the reference signal based on a ratio of a signal strength of the reference signal to a signal strength of a predetermined resource including a resource to which the reference signal is transmitted, and the third measurement method being a method for measuring a signal-to-noise ratio (SINR) of the reference signal based on a ratio of the signal strength of the reference signal to a signal strength of interference and noise in the same resource as the reference signal; select, based on the priorities, one of, or a combination of two or more of the first to third measurement methods for performing measurement of the reference signal; perform, with the selected measurement method or methods, measurement of radio signals transmitted from the base station apparatus and another base station apparatus different from the base station apparatus; and control connection with the base station apparatus according to a result of the measurement.

According to the present invention, it is possible to provide a technique for enabling appropriate control of measurement methods of reference signals performed by a terminal apparatus.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing an example of a configuration of a wireless communication system;

FIG. 2 is a diagram showing a placement of reference signals;

FIG. 3A is a diagram showing a measurement resource of SS-RSRP;

FIG. 3B is a diagram showing a measurement resource of SS-RSRQ;

FIG. 3C is a diagram showing a measurement resource of SS-SINR;

FIG. 4A is a diagram showing the correspondence between states of a conventional terminal and measurement methods;

FIG. 4B is a diagram showing the correspondence between states of a terminal according to the present embodiment and measurement methods;

FIG. 5 is a diagram showing a hardware configuration of a base station apparatus and a terminal apparatus;

FIG. 6A is a software functional diagram of the base station apparatus;

FIG. 6B is a software functional diagram of the terminal apparatus;

FIG. 7 is a diagram showing options for indices used for mobility control;

FIG. 8A is a diagram showing an example of a notification signal transmitted by the base station apparatus;

FIG. 8B is a diagram showing an example of a notification signal transmitted by the base station apparatus;

FIG. 8C is a diagram showing an example of a notification signal transmitted by the base station apparatus; and

FIG. 9 is a diagram showing an example of processing performed by the terminal apparatus.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### (Configuration of Wireless Communication System)

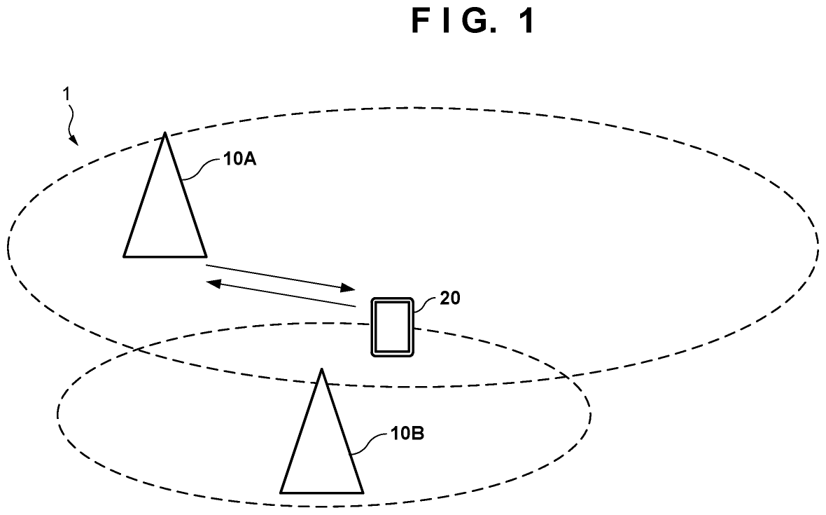

FIG. 1 shows an example of a configuration of a wireless communication system according to the present embodiment. A wireless communication system 1 is, for example, a cellular communication system configured in compliance with a cellular communication standard such as the 5th Generation (5G) standard or the 4th Generation (4G) of the 3rd Generation Partnership Project (3GPP (registered trademark). The wireless communication system includes base station apparatuses 10A and 10B (may also be referred to as a base station apparatus 10 without making distinction therebetween), and a terminal apparatus 20.

Note that FIG. 1 shows only two base station apparatuses and one terminal apparatus in order to facilitate description; however, it is of course possible that one base station apparatus, three or more base station apparatuses, and a plurality of terminal apparatuses exist. The base station apparatus 10 forms one or more cells, and provides communication to the terminal apparatus 20 to which the base station apparatus 10 is connected. The terminal apparatus 20 can be connected to the cell or cells formed by the base station apparatus 10. In the example shown in FIG. 1, it is assumed that the terminal apparatus 20 is connected to the base station apparatus 10A.

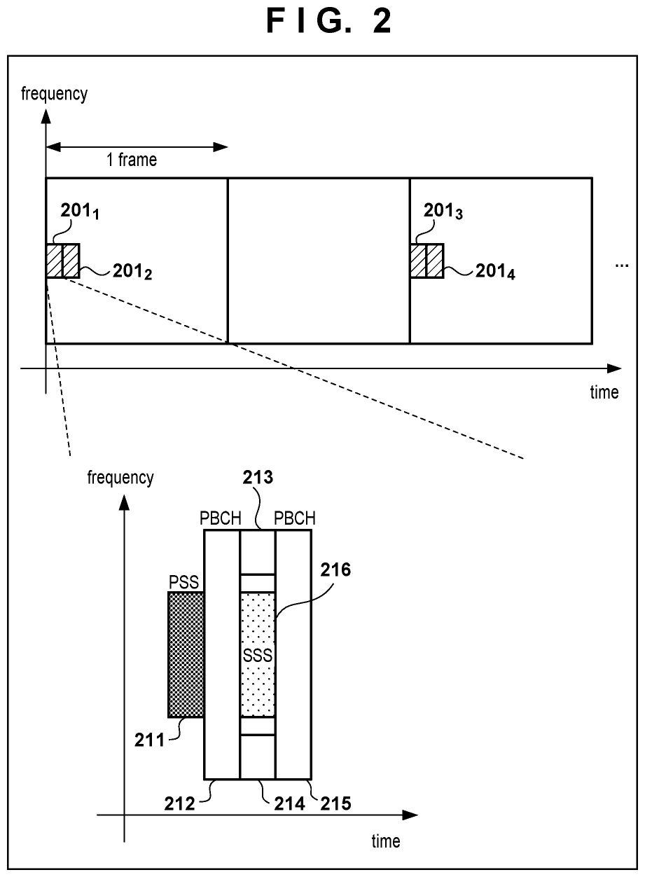

With reference to FIGS. 2 to 5, problems in the conventional mobility control will be described.

FIG. 2 shows a placement of resources measured by the terminal apparatus 20 in mobility control such as handover. The horizontal axis represents the time, and the vertical axis represents the frequency.

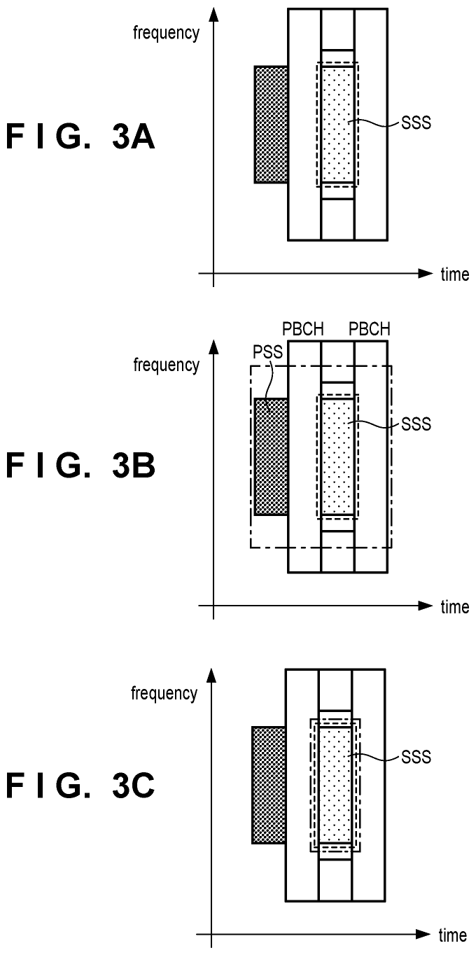

Synchronization signal and physical broadcast channel blocks (SS/PBCH blocks) 2011 to 2014 (hereinafter may be referred to as an SS/PBCH block 201 without making distinction therebetween) including reference signals measured at predetermined time intervals by the terminal apparatus 20 are placed between radio frames. Here, the terminal apparatus 20 measures at least a portion of the resource of the SS/PBCH block 201, and performs handover according to the measurement result. Methods with which the terminal apparatus 20 performs the measurement of the SS/PBCH block will be described later with reference to FIGS. 3A to 3C.

The SS/PBCH block 201 includes a primary synchronization signal (PSS) 211, physical broadcast channels (PBCH) 212 to 215, and a secondary synchronization signal (SSS) 216.

Three methods are available as methods with which the terminal apparatus 20 measures a radio signal including a reference signal transmitted from a base station apparatus.

A first measurement method shown in FIG. 3A is a method for measuring synchronization signal reference signal received power (SS-RSRP). In the first measurement method for measuring SS-RSRP, the received power of an SSS per resource element is evaluated. Since only the received power of the SSS is evaluated in the first measurement method, the presence or absence of an interference signal is not taken into consideration. Note that, in the first measurement method, the terminal apparatus 20 may measure, as the SS-RSRP, measurement results of the received power of a plurality of SSSs, such as an average received power of a plurality of SSSs.

A second measurement method shown in FIG. 3B is a method for measuring synchronization signal reference signal reception quality (SS-RSRQ). In the second measurement method, SS-RSRQ is calculated based on the expression: SS-RSRQ=N×SS-RSRP/RSSI. Here, the RSSI is the overall received signal strength indicator of an SS/PBCH block, and N is the number of resource blocks for which the RSSI is measured, and N=20, for example. Measurement parameters such as Symbol and N for measuring the RSSI can be changed for each terminal apparatus 20, or for each cellular network. In this case, the RSSI may constitute a part of an SS/PBCH block, and may be the signal strength of a resource including SSS.

A third measurement method shown in FIG. 3C is a method for measuring a synchronization signal signal-to-interference-plus-noise ratio (SS-SINR). In the third measurement method, the received power of a resource element of an SSS is divided by the power of the interference and noise in the same resource as the SSS. The terminal apparatus 20 estimates the power of the interference and noise in the same resource as the SSS using a known technique. For example, the terminal apparatus may estimate the signal strength of interference and noise based on a variance in the received signal strengths of a plurality of SSSs, and calculate the ratio using, as the SSS signal strength, a signal strength obtained by subtracting the estimated signal strength from the power of the measured SSS resource. In such a case, the larger the variance, the higher the power of the interference and noise is determined to be. Alternatively, the power of a different resource such as a demodulation reference signal (DMRS) may be used to estimate the power of the interference and noise in the same resource as the SSS.

While both SS-RSRQ and SS-SINR take interference and noise into consideration, a measurement result of the SS-RSRQ is calculated so as to include a resource different from that of the SS-SINR. Therefore, depending on the radio propagation environment from the base station apparatus 10 to the terminal apparatus 20, the frequency of the interference signal, and the measurement parameters, it may not be possible to appropriately evaluate the communication quality of a candidate cell serving as a handover candidate.

The terminal apparatus 20 can determine the occurrence of a trigger event that triggers a handover to the base station apparatus 10 by evaluating the communication quality of a cell as a key performance indicator (KPI) in accordance with one of, or a combination of two or more of the three measurement methods as shown in FIGS. 3A to 3C, and comparing the KPI with a predetermined threshold.

Here, conventionally, measurement methods that can be used by the terminal apparatus 20 differ depending on the connected state (RRC state) with the base station apparatus 10.

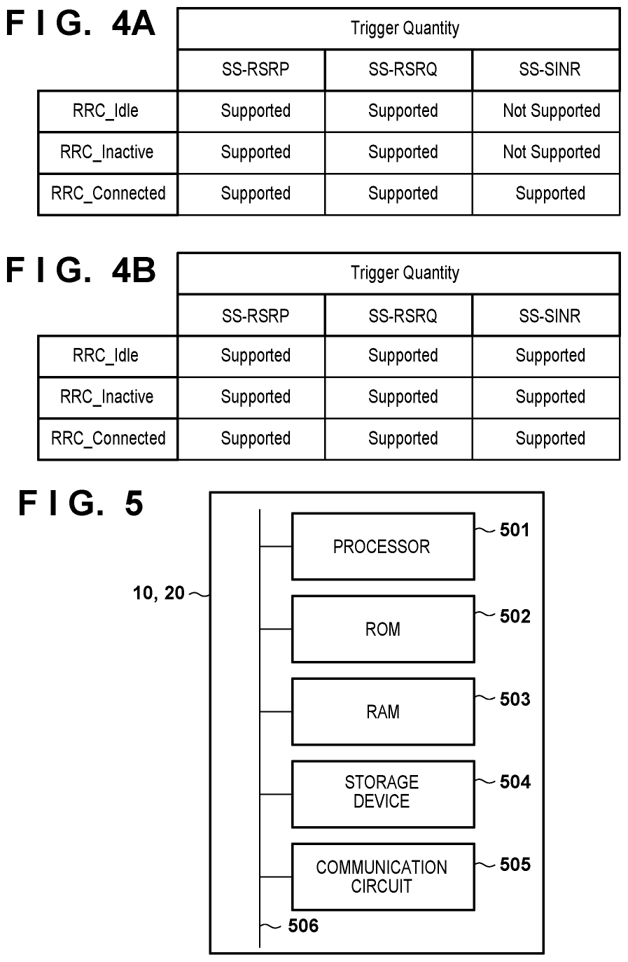

FIG. 4A shows measurement methods used by the conventional terminal apparatus 20 for the respective RRC states. In an idle (RRC-Idle) state or an inactive (RRC-Inactive) state, the conventional terminal apparatus 20 does not perform measurement with the third measurement method for measuring SS-SINR. The reason for this is to reduce the battery consumption of the terminal apparatus 20. However, in such a case, handover may be repeated as a result of using different measurement methods according to the RRC state of the terminal apparatus 20, as will be described below.

(1) The terminal apparatus 20 is connected to a cell formed by the base station apparatus 10A in a connected (RRC-Connected) state. Here, the terminal apparatus 20 measures the SS-SINR of an SS/PBCH block transmitted from the base station apparatus 10B with the third measurement method, to detect a trigger event, and performs a handover to a cell formed by the base station apparatus 10B.

(2) After performing the handover to the cell formed by the base station apparatus 10B, the terminal apparatus 20 transitions to the idle state. Thereafter, the terminal apparatus 20 that has measured the SS-RSRP of the SS/PBCH block transmitted from the base station apparatus 10A with the first measurement method in the idle state detects a trigger event, and performs a handover to the cell formed by the base station apparatus 10A. Here, it is assumed that the SS-RSRP of the SS/PBCH block transmitted from the base station apparatus 10A is large due to, for example, a large signal strength of the interference and noise, but does not satisfy a threshold of the SS-SINR.

(3) After performing the handover to the cell formed by the base station apparatus 10A, the terminal apparatus 20 transitions to the connected state. Thereafter, the terminal apparatus 20 measures the SS-SINR of an SS/PBCH block transmitted from the base station apparatus 10B in the connected state with the third measurement method, to detect a trigger event, and performs a handover to the cell formed by the base station apparatus 10B.

As a result of the terminal apparatus 20 repeating handovers in this manner, a large amount of signaling occurs, resulting in the problem of an increased network resource consumption and increased loads on the terminal apparatus 20 and the base station apparatus 10 associated with the signaling.

FIG. 4B shows measurement methods used by the terminal apparatus 20 according to the present embodiment for the respective RRC states. In the idle (RRC-Idle) state or the inactive (RRC-Inactive) state, the terminal apparatus 20 according to the present embodiment is capable of performing measurement with the third measurement method for measures SS-SINR. This can prevent the terminal apparatus 20 from repeating handover as a result of performing measurement with different methods depending on the RRC state.

The base station apparatus 10 according to the present embodiment transmits a notification to the terminal apparatus 20 so as to perform the third measurement method with a high priority. Based on the notification, the terminal apparatus 20 performs measurement with the third measurement method also in the idle state and the inactive state, and thus can perform a handover according to the same criteria as the connected state.

### (Hardware Configuration)

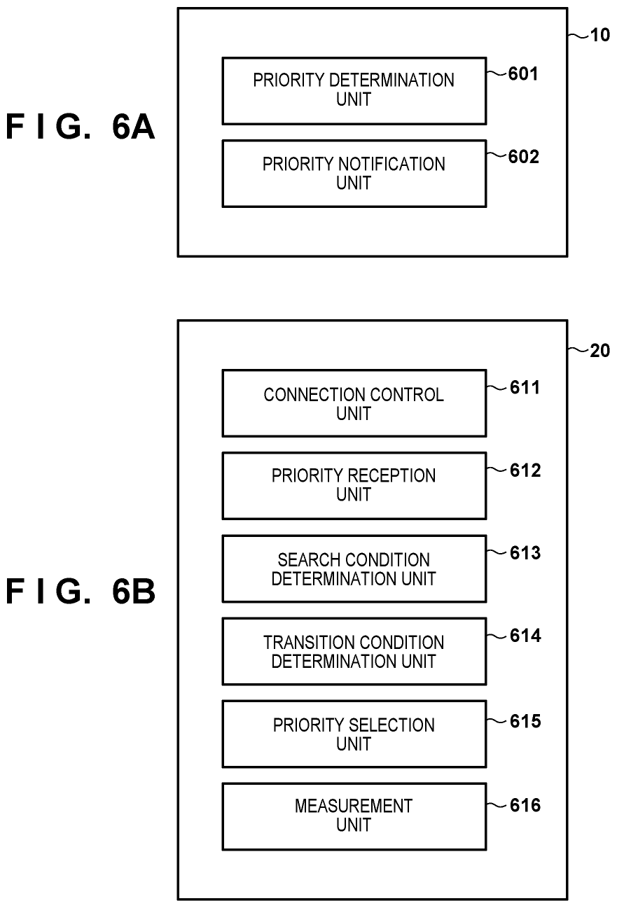

With reference to FIG. 5, a hardware configuration of the base station apparatus 10 and the terminal apparatus 20 according to the present embodiment will be described.

The base station apparatus 10 and the terminal apparatus 20 each include a processor 501, a ROM 502, a RAM 503, a storage device 504, and a communication circuit 505. The constituent elements 501 to 505 are connected to each other in a communication-enabling manner via a bus 506.

The processor 501 is a computer including one or more processing circuits such as a general-purpose central processing unit (CPU) and an application specific integrated circuit (ASIC), and functions as a control unit that performs overall control of the base station apparatus 10 and the terminal apparatus 20 by reading out a program stored in the ROM 502 or the storage device 504 and executing the program. The ROM 502 is a read-only memory that stores information such as a program executed by the base station apparatus 10 and the terminal apparatus 20, and various parameters. The RAM 503 is a random access memory that functions as a workspace when the processor 501 executes the program, and that stores transitory information. The storage device 504 is constituted, for example, by a removable external storage device or the like. The communication circuit 505 is constituted, for example, by a wireless communication circuit such as a Long Term Evolution (LTE) or 5th Generation Mobile Communication System (5G). In an example, the base station apparatus 10 may include a wired communication circuit that can be used for communication between base stations. Note that, although FIG. 5 illustrates one communication circuit 505, the base station apparatus 10 and the terminal apparatus 20 may each include a plurality of communication circuits. For example, the base station apparatus 10 and the terminal apparatus 20 may each include wireless communication circuits respectively used for LTE (4G), 5G, and successors thereof, and an antenna shared by these circuits. Note that the base station apparatus 10 and the terminal apparatus may each include separate antennas conforming to the respective standards. The base station apparatus 10 may further include a wired communication circuit used when communicating with another base station apparatus or a core network node. The terminal apparatus 20 may further include a communication circuit or the like compliant with a wireless communication standard other than cellular communication standards such as wireless local area network (LAN) and Bluetooth (registered trademark). Note that the base station apparatus 10 and the terminal apparatus 20 may each include separate communication circuits 505 for a plurality of usable frequency bands, or may include a common communication circuit 505 shared by at least some of the frequency bands.

### (Software Configuration)

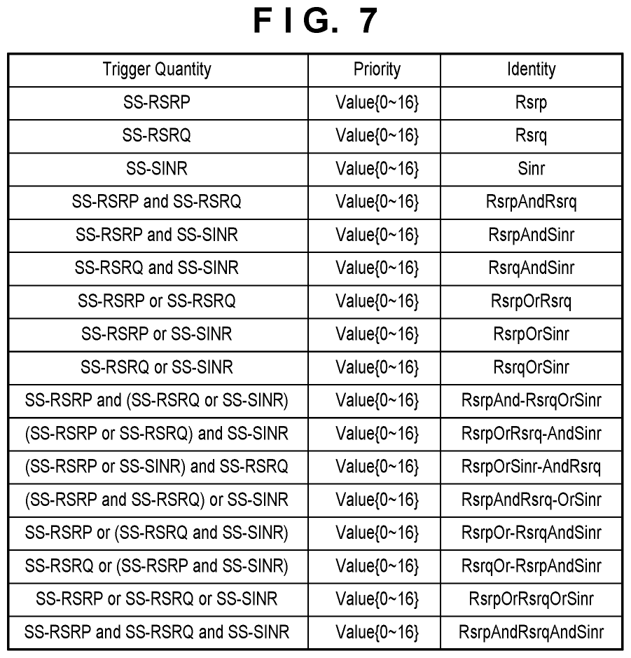

With reference to FIG. 6A, the functional configuration of the base station apparatus 10 will be described. The base station apparatus 10 functions as a priority determination unit 601 and a priority notification unit 602 by the processor 501 reading out a program stored in the ROM 502 or the storage device 504 and executing the program. Note that, although FIG. 6A illustrates only the functions relating to the present embodiment, the illustration of other functions that the base station may include has been omitted.

The priority determination unit 601 determines whether to cause the terminal apparatus 20 to perform a control operation such as cell search and handover (pixel transition) using a combination of conditions relating to a measured value of a resource including a reference signal that the terminal apparatus 20 has measured with one, or a plurality of the first to third measurement methods.

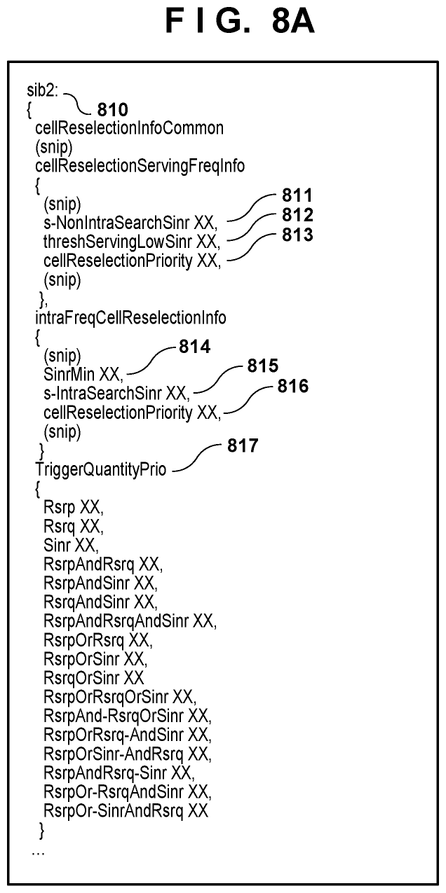

Here, with reference to FIG. 7, an example of combinations of measurement methods determined by the base station apparatus 10 will be described. The base station apparatus 10 determines at least one combination of measurement methods in association with a priority with which the terminal apparatus 20 is caused to perform the combination of measurement methods. For example, “SS-RSRP” indicates a condition that enables execution of a control operation of the terminal apparatus 20 at a measured value obtained with the first measurement method. “SS-RSRQ and SS-SINR” is a condition that enables execution of a control operation provided that measured values satisfy the condition both in the second measurement method and the third measurement method. “SS-RSRP and (SS-RSRQ or SS-SINR)” is a condition that enables execution of a control operation provided that a measurement result obtained with the first measurement method satisfies the condition, and that a measurement result obtained with the second measurement method or the third measurement method satisfies the condition. Depending on the capability of the terminal apparatus 20, the terminal apparatus 20 may not accommodate at least one of the first to third measurement methods. In such a case, when the terminal apparatus 20 is in a standby state, the base station apparatus 10 cannot determine which of the measurement methods that the terminal apparatus 20 accommodates. For this reason, the base station apparatus 10 determines priorities of the measurement methods that the terminal apparatus 20 is caused to perform, and notifies the terminal apparatus 20 of the priorities. Accordingly, if the terminal apparatus 20 accommodates a measurement method with a high priority, the base station apparatus 10 can cause the terminal apparatus 20 to perform measurement of a reference signal with the measurement method with a high priority, and, otherwise, can cause the terminal apparatus 20 to perform measurement of a reference signal with a measurement method that the terminal apparatus 20 accommodates and that has a lower priority than the measurement method with a high priority.

For these priorities, “Priority” is set as 0 to 16 priorities for each trigger (Trigger Quantity) candidate. The larger the numerical value of Priority, the higher the priority that is indicated. These priorities are set in advance by the base station apparatus 10. “Identity” is an identifier used for transmitting a notification to the terminal apparatus 20 in association with Priority. Note that, in the present embodiment, the upper limit of the values of priorities is set as 17, which is the number of combinations of measurement methods, the range of the values of priorities can be changed as appropriate according to the number of the combinations.

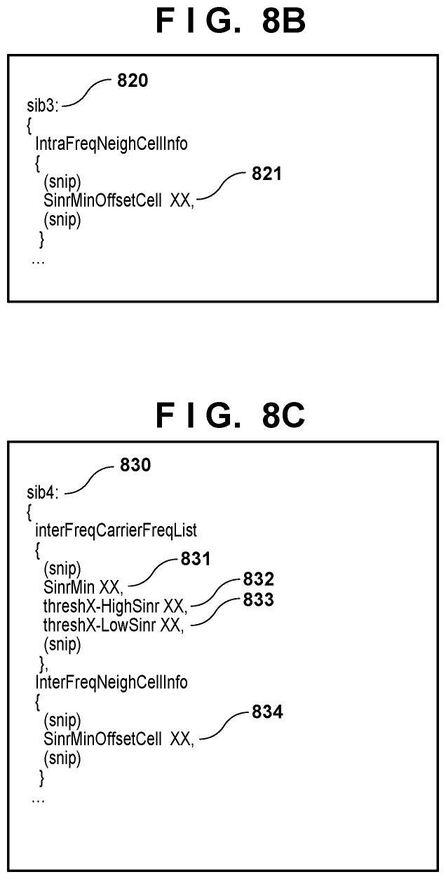

In the manner described below with reference to FIGS. 8A to 8C, the priority notification unit 602 notifies, with a notification signal, the terminal apparatus 20 of the priority for a method or a combination of methods for measuring the reference signal transmitted by the base station apparatus 10. Note that the identifiers and the priorities are not limited thereto, and different identifiers and a different range of priorities may be set.

For example, the base station apparatus 10 transmits an instruction indicating a measurement method to be used when causing the terminal apparatus 20 to perform measurement of a reference signal by including the instruction in a system information block (SIB) message.

With reference to FIGS. 8A to 8C, an example of information relating to the priorities transmitted by the base station apparatus 10 to the terminal apparatus 20 will be described.

FIG. 8A shows a system information block type 2 (SIB2) message broadcasted at a predetermined period. An SIB2 message 810 includes s-NonIntraSearchSinr 811, threshServingLowSinr 812, CellReselectionPriority 813, SinrMin 814, s-IntraSearchSinr 815, and TriggerQuantityPrio 816. Hereinafter, these information elements (IEs) will be referred to as IEs 811 to 816 without making distinction therebetween.

The IE 811 is a threshold of measured values of a reference signal in a cell (resident cell) in which the terminal apparatus 20 resides, and is used as a condition for searching for a handover candidate cell (candidate cell) in a band different from that of the resident cell. The IE 812 is a threshold of measured values of a reference signal in the resident cell, and is used as a condition for transitioning to a candidate cell in a band different from the handover source. The IE 813 indicates the priority for cell reselection. The IE 814 is a threshold of measured values of a reference signal in the resident cell, and is used as a condition for starting search for a candidate cell in the same band as the resident cell. The IE 815 is a threshold of measured values of a reference signal in the resident cell, and is used as a condition for transitioning to a candidate cell in the same band as the resident cell. The IE 816 indicates the priority for the measurement method, and the priority and the identifier described with reference to FIG. 7 are stored therein in association with each other.

FIG. 8B shows a system information block type 3 (SIB3) message broadcasted at a predetermined period. An SIB3 message 820 includes SinrMinOffsetCell 821. The SinrMinOffsetCell 821 is an IE indicating an offset between the measured value of a reference signal of a resident cell and the measured value of a reference signal of a candidate cell when performing a handover. For example, it is determined that a handover to the candidate cell is performed if the measured value of the candidate cell is higher than the measured value of the resident cell by the SinrMinOffsetCell or more.

FIG. 8C shows a system information block type 4 (SIB4) message broadcasted at a predetermined period. An SIB4 message 830 includes SinrMin 831, threshX-HighSinr 832, threshX-LowSinr 833, and SinrMinOffsetCell 834. Hereinafter, these information elements (IEs) will be referred to as IEs 831 to 834 without making distinction therebetween.

The IEs 831 and 834 are the same as the IEs 814 and 821, and therefore descriptions thereof have been omitted. Each of the IEs 832 and 833 is a threshold of measured values of a candidate cell that is used as a condition for transitioning to the candidate cell.

By the terminal apparatus 20 receiving these SIB messages, the terminal apparatus 20 can perform the processing described below, thus performing mobility control processing including cell search and handover.

With reference to FIG. 6B, the functional configuration of the terminal apparatus 20 will be described. The terminal apparatus 20 functions as a connection control unit 611, a priority reception unit 612, a search condition determination unit 613, a transition condition determination unit 614, a priority selection unit 615, and a measurement unit 616 by the processor 501 reading out a program stored in the ROM 502 or the storage device 504 and executing the program. Note that, although FIG. 6B illustrates only the functions relating to the present embodiment, the illustration of other functions that the terminal apparatus 20 may include has been omitted.

The connection control unit 611 controls the state of communication between the terminal apparatus 20 and the base station apparatus 10, and perform transition to the idle state, the inactive state, or the connected state described above.

The priority reception unit 612 receives a notification signal including priorities that have been transmitted from the base station apparatus 10. Based on the information about the priorities received by the priority reception unit 612, the search condition determination unit 613 determines whether the condition for searching for a handover destination cell is satisfied. Based on the information about the priorities received by the priority reception unit 612, the transition condition determination unit 614 determines whether to perform a handover. Based on the information relating to the priorities received by the priority reception unit 612, the priority selection unit 615 selects one measurement method or a plurality of measurement methods with which measurement is to be performed. For example, even when the third measurement method is set to a high priority in the information relating to the priorities, the priority selection unit 615 selects to perform a measurement method or a combination of measurement methods with a lower priority if the terminal apparatus 20 is set not to perform the third measurement method when the terminal apparatus 20 is in the idle state or the inactive state. The measurement unit 616 performs measurement based on the received information relating to the priority.

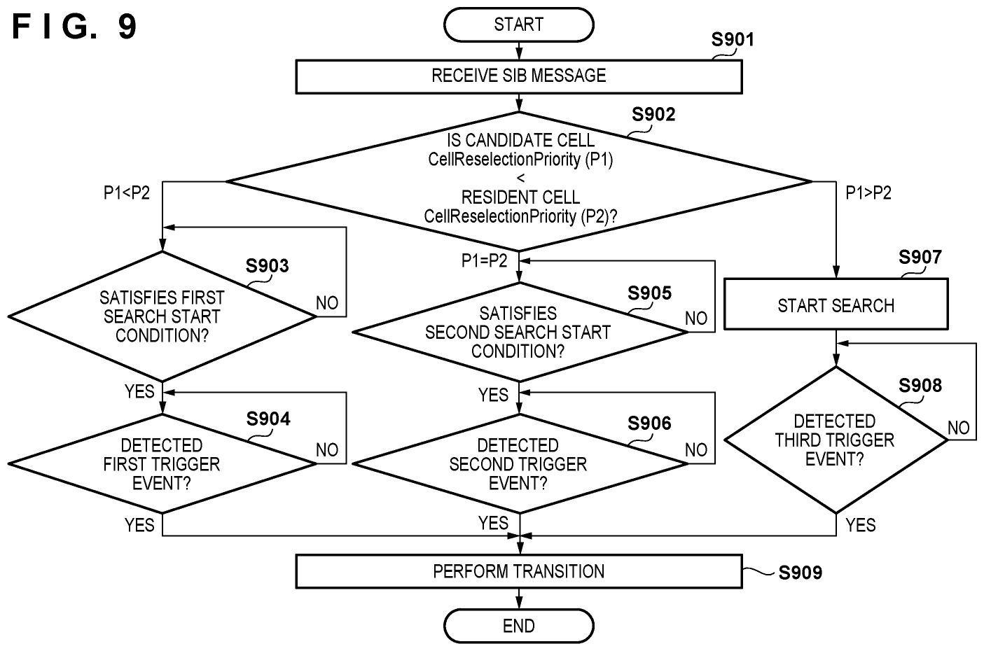

With reference to FIG. 9, an example of processing performed by the terminal apparatus 20 will be described. The processing shown in FIG. 9 is performed by the processor 501 of the terminal apparatus 20 reading out a program stored in the ROM 502 or the storage device 504 and executing the program. Note that the terminal apparatus 20 performs the processing shown in FIG. 9 when the terminal apparatus 20 has transitioned to the idle state or the inactive state.

In S901, the terminal apparatus 20 obtains SIB messages transmitted from the base station apparatuses 10 of a cell (resident cell) in which the terminal apparatus 20 currently resides, and a cell (candidate cell) serving as a handover destination candidate. Here, the terminal apparatus 20 is in the idle state or the inactive state, and therefore can receive SIB messages of the resident cell and the candidate cell. Note that, in the present embodiment, RsrpAndSinr, which compares the measured values of the first and third measurement methods with the thresholds, is set to have the highest priority as the priority for the measurement method designated by the base station apparatus 10 of the resident cell. Subsequently, the terminal apparatus 20 compares CellReselectionPriority (P1) included in the SIB message transmitted from the base station apparatus of the candidate cell with CellReselectionPriority (P2) included in the SIB message of the resident cell (S902).

If P1 is less than P2 (P1<P2 in S902), the terminal apparatus 20 advances the processing to S903, in which the terminal apparatus 20 measures a reference signal of the resident cell, and determines whether a first search start condition, which is a condition for starting search for a handover destination, is satisfied (S903). The first search start condition is, for example, that the measured values of the resident cell that have been measured with the first and third measurement methods are below the thresholds. That is, the terminal apparatus 20 advances the processing to S904 provided that the SS-RSRP of the resident cell is below sNonIntraSearchP, and the SS-SINR of the resident cell is below sNonIntraSearchSinr. If the condition is not satisfied (NO in S903), the terminal apparatus 20 repeats measurement of the reference signal with the first and third measurement methods at predetermined time periods. If the first search start condition is satisfied (YES in S903), the terminal apparatus 20 starts cell search, and determines whether a first transition condition is satisfied (S904). In the cell search, in accordance with an instruction indicating the priorities for the measurement methods, received from the base station apparatus 10, the terminal apparatus 20 performs measurement of reference signals transmitted from the base station apparatuses 10 of the candidate cell and the resident cell. In RsrpAndSinr, the reference signal is measured with the first and third measurement methods, and the measured values are compared with the thresholds. Specifically, a condition is set that, for a predetermined timer (tReselectionNR), (1) the SS-RSRP of the resident cell is below threshServingLowP, and the SS-RSRP of the candidate cell is above threshXLowP, and (2) the SS-SINR of the resident cell is below threshServingLowSinr, and the SS-SINR of the candidate cell is above threshXLowSinr. If it is determined that the first transition condition is satisfied (YES in S904), the terminal apparatus 20 advances the processing to S909.

If P1 and P2 are equal (P1=P2 in S902), the terminal apparatus 20 advances the processing to S905, in which the terminal apparatus 20 starts cell search, performs measurement of the reference signal of the resident cell, and determines whether a second search start condition, which is a condition for starting search for a handover destination, is satisfied (S905). The second search start condition is, for example, that the measured values of the resident cell measured with the first and third measurement methods are below the thresholds. For example, if a neighboring cell is in the same band as the resident cell, the terminal apparatus 20 advances the processing to S906, provided that the SS-RSRP of the resident cell is below sIntraSearchP, and the SS-SINR of the resident cell is below sIntraSearchSinr. If the neighboring cell is in a different band from the resident cell, the terminal apparatus 20 advances the processing to S906, provided that the SS-RSRP of the resident cell is below sNonIntraSearchP, and the SS-SINR of the resident cell is below sNonIntraSearchSinr. If the condition is not satisfied (NO in S905), the terminal apparatus 20 repeats measurement of the reference signals with the first and third measurement methods at predetermined time periods. If the second search start condition is satisfied (YES in S905), the terminal apparatus 20 determines whether a second transition condition is satisfied (S906). Here, in accordance with the notification indicating the priorities for the measurement methods, received from the base station apparatus 10, the terminal apparatus 20 compares the measured values of the reference signal obtained with he first and third measurement methods with the thresholds. Specifically, a condition is set such that, for the predetermined timer (tReselectionNR), the SS-RSRP of the candidate cell is greater than SS-RSRP+offset (qHyst) of the resident cell, in addition to the second search start condition. If it is determined that the second transition condition is satisfied (YES in S906), the terminal apparatus 20 advances the processing to S909.

If P1 is greater than P2 (P1>P2 in S902), the terminal apparatus 20 advances the processing to S907, in which the terminal apparatus 20 starts cell search of a handover destination (S907). Subsequently, the terminal apparatus 20 determines whether a third transition condition is satisfied (S908). Here, in accordance with the notification indicating the priorities for the measurement methods, received from the base station apparatus 10, the terminal apparatus 20 compares the measured values of the reference signal obtained with the first and third measurement methods with the thresholds. Specifically, a condition is set such that, for the predetermined timer (tReselectionNR), the SS-RSRP of the candidate cell is greater than a threshold threshXHighP, and the SS-SINR of the candidate cell is greater than threshXHighSinr. If it is determined that the third transition condition is satisfied (YES in S908), the terminal apparatus 20 advances the processing to S909.

In S909, the terminal apparatus 20 performs mobility control processing such as execution of cell reselection.

As described thus far, according to the present embodiment, the terminal apparatus compares the signal strength of a reference signal transmitted from the base station apparatus with the signal strength of an interference signal according to the same criteria, regardless of the connected state with the base station apparatus, and performs measurement of a radio signal transmitted from the base station apparatus. This enables mobility control to be performed according to appropriate criteria in the idle state and the inactive state.

Furthermore, according to the present embodiment, the terminal apparatus uses the same criteria to perform mobility control such as cell search and pixel transition, regardless of the connected state with the base station apparatus. This can prevent handover from being frequently repeated according to different criteria depending on the connected state.

The invention is not limited to the foregoing embodiments, and various variations/changes are possible within the spirit of the invention.

What is claimed is:

1. A terminal apparatus comprising:
at least one processor; and
a memory;
wherein the at least one processor is configured, by executes executing computer executable instructions stored in the memory, to:
receive a notification signal from a base station apparatus, the notification signal including information indicating respective priorities for one of, and a combination of two or more of a first measurement method, a second measurement method, and a third measurement method, the first measurement method being a method for measuring received power of a reference signal transmitted from the base station apparatus, the second measurement method being a method for measuring reception quality of the reference signal based on a ratio of a signal strength of the reference signal to a signal strength of a predetermined resource including a resource to which the reference signal is transmitted, and the third measurement method being a method for measuring a signal-to-noise ratio (SINR) of the reference signal based on a ratio of the signal strength of the reference signal to a signal strength of interference and noise in the same resource as the reference signal;
select, based on the priorities, one of, or a combination of two or more of the first to third measurement methods for performing measurement of the reference signal;
perform, with the selected measurement method or methods, measurement of radio signals transmitted from the base station apparatus and another base station apparatus different from the base station apparatus; and
control connection with the base station apparatus according to a result of the measurement.

2. The terminal apparatus according to claim 1, wherein
the reference signal is a secondary synchronization signal (SSS), and
the predetermined resource is a synchronization signal and physical broadcast channel block (SS/PBCH block).

3. The terminal apparatus according to claim 1, wherein
the notification signal is a system information block (SIB) message.

4. The terminal apparatus according to claim 1, wherein
a measurement method or a combination of two or more measurement methods, for which the priority included in the notification signal is highest, is selected, from among a measurement method executable by the terminal apparatus and a combination of two or more measurement methods.

5. The terminal apparatus according to claim 1, wherein
an SIB message indicating a priority for cell reselection is received from each of the base station apparatus and the other base station apparatus, and
a threshold for controlling connection is determined based on the priorities for cell reselection of the base station apparatus and the other base station apparatus.

6. The terminal apparatus according to claim 1, wherein
in the measurement, received strengths of a plurality of reference signals in the third measurement method is measured, and a signal strength of interference and noise is estimated based on a variance in the measured received strengths of the plurality of reference signals.

7. A base station apparatus comprising:
at least one processor; and
a memory;
wherein the at least one processor is configured, by executes executing computer executable instructions stored in the memory, to:
determine respective priorities with which a terminal apparatus is caused to perform measurement for one of, and a combination of two or more of a first measurement method, a second measurement method, and a third measurement method, the first measurement method being a method for measuring received power of a reference signal, the second measurement method being a method for measuring reception quality of the reference signal based on a ratio of a signal strength of the reference signal to a signal strength of a predetermined resource including a resource to which the reference signal is transmitted, and the third measurement method being a method for measuring a signal-to-noise ratio (SINR) of the reference signal based on a ratio of the signal strength of the reference signal to a signal strength of interference and noise in the same resource as the reference signal; and
notify the priorities.

8. The base station apparatus according to claim 7, wherein
the priorities are notified via a system information block (SIB) message.

9. The base station apparatus according to claim 7, the at least one processor is further configured, by executes executing computer executable instructions stored in the memory, to:
receive, from the terminal apparatus, a measurement report of radio signals transmitted from the base station apparatus and another base station different from the base station apparatus; and
control connection with the terminal apparatus based on the measurement report.

10. A control method of a terminal apparatus, comprising:
receiving a notification signal from a base station apparatus, the notification signal including information indicating respective priorities for one of, and a combination of two or more of a first measurement method, a second measurement method, and a third measurement method, the first measurement method being a method for measuring received power of a reference signal transmitted from the base station apparatus, the second measurement method being a method for measuring reception quality of the reference signal based on a ratio of a signal strength of the reference signal to a signal strength of a predetermined resource including a resource to which the reference signal is transmitted, and the third measurement method being a method for measuring a signal-to-noise ratio (SINR) of the reference signal based on a ratio of the signal strength of the reference signal to a signal strength of interference and noise in the same resource as the reference signal;
selecting, based on the priorities, one of, or a combination of two or more of the first to third measurement methods for performing measurement of the reference signal;
performing, with the selected measurement method or methods, measurement of radio signals transmitted from the base station apparatus and another base station apparatus different from the base station apparatus; and
controlling connection with the base station apparatus according to a measurement result.

11. A control method of a base station apparatus, comprising:
determining respective priorities with which a terminal apparatus is caused to perform measurement for one of, and a combination of two or more of a first measurement method, a second measurement method, and a third measurement method, the first measurement method being a method for measuring received power of a reference signal, the second measurement method being a method for measuring reception quality of the reference signal based on a ratio of a signal strength of the reference signal to a signal strength of a predetermined resource including a resource to which the reference signal is transmitted, and the third measurement method being a method for measuring a signal-to-noise ratio (SINR) of the reference signal based on a ratio of the signal strength of the reference signal to a signal strength of interference and noise in the same resource as the reference signal; and
notifying the determined priorities.

12. A non-transitory computer-readable storage medium storing a computer program which causes a computer of a terminal apparatus to execute:
receiving a notification signal from a base station apparatus, the notification signal including information indicating respective priorities for one of, and a combination of two or more of a first measurement method, a second measurement method, and a third measurement method, the first measurement method being a method for measuring received power of a reference signal transmitted from the base station apparatus, the second measurement method being a method for measuring reception quality of the reference signal based on a ratio of a signal strength of the reference signal to a signal strength of a predetermined resource including a resource to which the reference signal is transmitted, and the third measurement method being a method for measuring a signal-to-noise ratio (SINR) of the reference signal based on a ratio of the signal strength of the reference signal to a signal strength of interference and noise in the same resource as the reference signal;
selecting, based on the priorities, one of, or a combination of two or more of the first to third measurement methods for performing measurement of the reference signal;
performing, with the selected measurement method or methods, measurement of radio signals transmitted from the base station apparatus and another base station apparatus different from the base station apparatus; and
controlling connection with the base station apparatus according to a measurement result.

13. A non-transitory computer-readable storage medium storing a computer program which causes a computer of a base station apparatus to execute:
determining respective priorities with which a terminal apparatus is caused to perform measurement for one of, and a combination of two or more of a first measurement method, a second measurement method, and a third measurement method, the first measurement method being a method for measuring received power of a reference signal, the second measurement method being a method for measuring reception quality of the reference signal based on a ratio of a signal strength of the reference signal to a signal strength of a predetermined resource including a resource to which the reference signal is transmitted, and the third measurement method being a method for measuring a signal-to-noise ratio (SINR) of the reference signal based on a ratio of the signal strength of the reference signal to a signal strength of interference and noise in the same resource as the reference signal; and
notifying the determined priorities.
